(19) United States
(12) Patent Application Publication
(10) Pub. No.: US 2021/0266733 A1
(43) Pub. Date: Aug. 26, 2021

(54) SYSTEMS AND METHODS FOR OUT-OF-BAND TRANSFER OF INFORMATION TO MOBILE DEVICES

(71) Applicant: SCHNEIDER ELECTRIC IT CORPORATION, West Kingston, RI (US)

(72) Inventors: Joseph Bushmeyer, Dardenne Prairie, MO (US); Cory D. Basden, Arnold, MO (US); John H. Bean, JR., Littlestown, PA (US)

(21) Appl. No.: 16/798,708

(22) Filed: Feb. 24, 2020

(51) Int. Cl. H04W 12/00; H04W 4/80; H04W 76/14; H04B 10/85; H04L 9/32; H04W 12/06

(52) U.S. Cl. CPC H04W 12/0017; H04W 4/80; H04W 12/06; H04B 10/85; H04L 9/3242; H04W 76/14

(57) ABSTRACT

Aspects of the disclosure include a peripheral device comprising at least one light-emitting device, a wireless communication interface, and at least one controller configured to receive a wireless connection request at the wireless communication interface, generate a secret value responsive to receiving the wireless connection request, control the light-emitting device to output a signal indicative of the secret value to an external device, receive, from the external device via the wireless communication interface, information indicative of the secret value, and establish a wireless connection with the external device via the wireless communication interface based on the receipt of the information indicative of the secret value.

### FIELD OF THE DISCLOSURE

At least one example in accordance with the present disclosure relates generally to wirelessly transmitting information. Certain wireless technology standards involve a “pairing” operation that is executed between two devices prior to the two devices wirelessly transmitting information. The pairing operation may include authentication and/or identification between the two devices whereby a first device transmits authentication information to a second device. The second device may subsequently return the authentication information to the first device to authenticate itself to the first device.

### SUMMARY

According to at least one aspect of the present disclosure a peripheral device comprising at least one light-emitting device, a wireless communication interface, and at least one controller configured to receive a wireless connection request at the wireless communication interface, generate a secret value responsive to receiving the wireless connection request, control the light-emitting device to output a signal indicative of the secret value to an external device, receive, from the external device via the wireless communication interface, information indicative of the secret value, and establish a wireless connection with the external device via the wireless communication interface based on the receipt of the information indicative of the secret value.

In various examples, the at least one light-emitting device is a multi-color light-emitting diode, and controlling the light-emitting device (LED) to output the signal indicative of the secret value includes controlling the multi-color LED to output a series of colors. In some examples, the at least one controller is further configured to generate a passkey by hashing the secret value with a hash table. In at least one example, the information indicative of the secret value is the passkey. In various examples, the at least one controller is configured to establish the wireless connection with the external device responsive to determining that the passkey generated by the peripheral device matches the information indicative of the secret value. In some examples, the wireless connection is a Bluetooth Low-Energy technology standard connection.

According to at least one aspect of the present disclosure, a non-transitory computer-readable medium storing thereon sequences of instructions for controlling a device comprising a light-emitting device and a wireless communication interface is provided, the sequences of computer-executable instructions including instructions that instruct at least one processor to receive a wireless connection request at the wireless communication interface, generate a secret value responsive to receiving the wireless connection request, control the light-emitting device to output a signal indicative of the secret value to an external device, receive, from the external device via the wireless communication interface, information indicative of the secret value, and establish a wireless connection with the external device via the wireless communication interface based on the receipt of the information indicative of the secret value.

In some examples, the at least one light-emitting device is a multi-color light-emitting diode (LED), and controlling the light-emitting device to output the signal indicative of the secret value includes controlling the multi-color LED to output a series of colors. In various examples, the instructions are further configured to instruct the at least one processor to generate a passkey by hashing the secret value with a hash table. In at least one example, the information indicative of the secret value is the passkey. In some examples, the instructions are further configured to instruct the at least one processor to establish the wireless connection with the external device responsive to determining that the passkey generated by the peripheral device matches the information indicative of the secret value. In various examples, the wireless connection is a Bluetooth Low-Energy technology standard connection.

According to at least one aspect of the present disclosure, a non-transitory computer-readable medium storing thereon sequences of instructions for controlling a device comprising a photosensor and a wireless communication interface is provided, the sequences of computer-executable instructions including instructions that instruct at least one processor to generate a wireless connection request, send the wireless connection request to a peripheral device via the wireless communication interface, receive, from the peripheral device, an electromagnetic radiation signal output by a light-emitting device and being indicative of a secret value, generate, based on the secret value, information indicative of the secret value, send the information indicative of the secret value to the peripheral device, and establish a wireless connection with the peripheral device via the wireless communication interface based on sending the information indicative of the secret value to the peripheral device.

In various examples, in instructing the at least one processor to receive the electromagnetic radiation signal output by the light-emitting device, the instructions are further configured to instruct the at least one processor to sense the electromagnetic radiation signal via the photosensor to acquire the secret value. In at least one example, the instructions are further configured to instruct the at least one processor to derive the secret value from the electromagnetic radiation signal to obtain the secret value. In some examples, the instructions are further configured to instruct the at least one processor to access a local hash table, and generate the information indicative of the secret value by hashing the secret value with the local hash table.

According to at least one aspect of the present disclosure, a method of operating a peripheral device including a light-emitting device and a wireless communication interface is provided, the method comprising receiving a wireless connection request at the wireless communication interface, generating a secret value responsive to receiving the wireless connection request, controlling the light-emitting device to output a signal indicative of the secret value to an external device, receiving, from the external device via the wireless communication interface, information indicative of the secret value, and establishing a wireless connection with the external device via the wireless communication interface based on the receipt of the information indicative of the secret value.

In various examples, controlling the light-emitting device to output the signal indicative of the secret value includes controlling the light-emitting device to output a series of colors. In at least one example, the method further comprises generating a passkey by hashing the secret value with a hash table. In some examples, the information indicative of the secret value is the passkey.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a communication system according to an embodiment;

FIG. 2 illustrates a process of operating a first device according to an example;

FIG. 3 illustrates a process of operating a second device according to an example;

FIG. 4 illustrates a process of transmitting information by the first device according to an example; and

FIG. 5 illustrates a process of receiving information by the second device according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are no intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

In both commercial and residential environments, users may desire to interact with a peripheral device. As used herein, a “peripheral device” is a device or piece of equipment capable of performing a task. For example, a peripheral device may include a cooling device such as a computer room air conditioning (CRAC) unit, an uninterruptible power supply, a dishwasher, a washing machine, or any other device configured for or otherwise capable of performing a task. Various media exist to enable communication between a user and a peripheral device. For example, a peripheral device may include a wireless communication interface that enables a user to interact, via a separate user device wirelessly coupled to the wireless communication interface, with the peripheral device.

Continuing with the example in which a peripheral device communicates wirelessly with a user device, the peripheral device and the user device may transmit and/or receive data encoded in electromagnetic waves, such as radio waves. To enable wireless communication in some examples, the user device and the peripheral device may be required to authenticate one another's identity in a process referred to as “pairing.” For example, pairing may be a necessary prerequisite to forming a wireless connection pursuant to a Bluetooth or Bluetooth Low-Energy (BLE) technology standard.

To establish a pairing between a peripheral device and a user device, such as a mobile device, authentication information may be securely exchanged between the peripheral device and the user device. Exchanging authentication information securely may be advantageous to avoid “man-in-the-middle” attacks, in which a malicious user acquires authentication information as it is exchanged. The malicious user may subsequently use the authentication information to pose as an authorized user to the peripheral device or the user device to obtain secret information from the peripheral device or the user device, or to attempt to control the peripheral device. Accordingly, it may be beneficial to securely exchange the authentication information used in forming a wireless connection without exposing the authentication information to third parties to avoid such man-in-the-middle attacks.

Various communication media may be used to provide pairing authentication information from a peripheral device to a user device. For example, the peripheral device may include a display screen that displays the connection information to a user of the user device. The peripheral device may be in a secure location, such that only authorized users have access to the peripheral device and thus only authorized users can read the display screen. The user may read the authentication information off of the display screen and manually input the authentication information into the user device via a physical interface (for example, via a touchscreen) of the user device. The user device, upon receiving the authentication information, may use the authentication information to pair with the peripheral device by sending the authentication information back to the peripheral device. The authentication information may be a one-time value such that, even if a malicious user acquires the authentication information, the malicious user cannot use the authentication information to form a wireless connection with the peripheral device. In this example, the peripheral device includes a display screen or similar device to display the authentication information.

In other examples, other communication media may be used to provide the authentication information from a peripheral device to a user device in a pairing operation. For example, the peripheral device may include a light-emitting device, such as a light-emitting diode (LED), capable of outputting electromagnetic radiation. The light-emitting device may be capable of operating in one of several states, each state including outputting an electromagnetic radiation signal of a respective visible color or not outputting any electromagnetic radiation. For example, example states include outputting red light, outputting blue light, not outputting any light, and so forth. The light-emitting device may encode information in a signal that includes a series of light-emitting device states.

The user device may include a photosensor capable of measuring an electromagnetic field. The photosensor may be capable of measuring the electromagnetic signal that encodes the authentication information, and output a signal (for example, a current signal) indicative of the encoded authentication information. The user device may include a processor and/or logic circuitry configured to decode the encoded authentication information and thereby acquire the authentication information. The user device may then pair with the peripheral device using the authentication information.

Accordingly, examples of disclosure enable a first electronic device to encode information in an electromagnetic radiation signal and transmit the electromagnetic radiation to a second electronic device to decode the encoded information. In one example, the first electronic device includes a light-emitting device to generate the electromagnetic radiation signal encoding the information, and the second electronic device includes a photosensor configured to receive and transduce the electromagnetic radiation signal for decoding. In one exemplary embodiment, the first electronic device may transmit pairing authentication information to the second electronic device to enable the second electronic device to pair with the first electronic device and thereby form a wireless connection (for example, a wireless connection pursuant to the Bluetooth Low-Energy technology standard) with the first electronic device. Thus, in this embodiment, the first and second electronic device may establish a wireless connection based on information transmitted via an electromagnetic radiation signal output by the light-emitting device. Although many other examples are within the scope of the disclosure, in one illustrative example, the peripheral device may be a cooling device (for example, a CRAC), and the user device may be a mobile computing device, such as a cellular telephone or tablet computer.

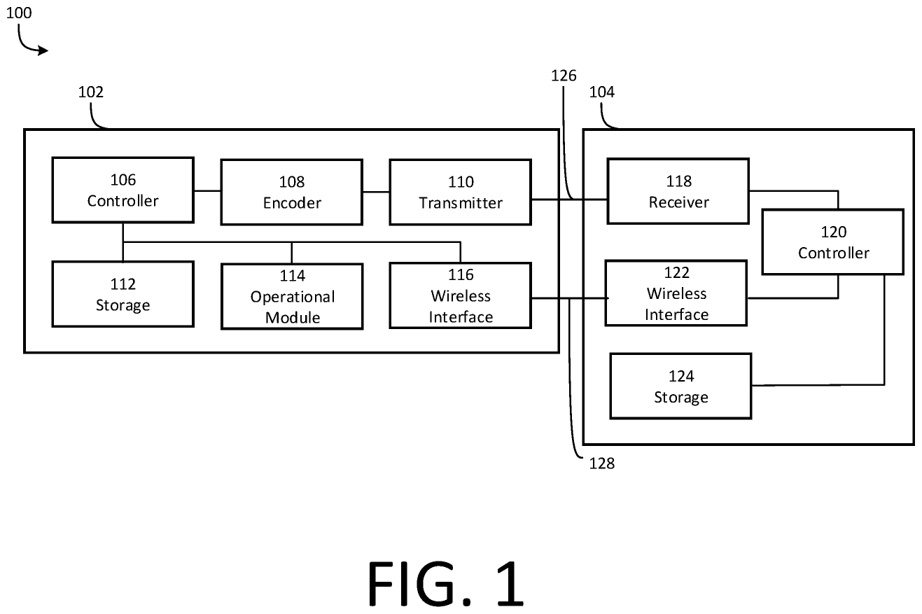

FIG. 1 illustrates a block diagram of a communication system 100 according to an embodiment. The communication system 100 includes a first device 102 and a second device 104. In one example, the first device 102 may be a peripheral device, such as a cooling device. The second device 104 may be a user device, such as a mobile computing device, operated by a user desiring to establish a wireless connection between the first device 102 and the second device 104.

The first device 102 includes a controller 106, an encoder 108, a transmitter 110, a storage module 112, an operational module 114, and a wireless interface 116. The second device 104 includes a receiver 116, a controller, and a wireless interface 122. The transmitter 110 of the first device 102 may be communicatively coupled to the receiver 118 of the second device 104 via a first communication medium 126. For example, the communication medium 126 may include visible electromagnetic radiation, a physical connection conducive to transmitting vibration signals, and so forth. The wireless interface 116 of the first device 102 may be communicatively coupled to the wireless interface 122 of the second device 104 via a second communication medium 128. For example, the communication medium 128 may include radio-wave electromagnetic radiation.

The controller 106 is configured to control operation of the first device 102. For example, where the first device 102 is a cooling device, the controller is configured to control one or more cooling components of the operational module 114. In addition, the controller 106 may execute a connection establishment procedure. As discussed in greater detail below, an example of the connection establishment procedure includes generating first connection information including authentication information (for example, a random value), and providing the first connection information to the second device 104 via the encoder 108 and the transmitter 110. The controller 106 subsequently receives second connection information (for example, a passkey generated from the random value) from the second device 104 via the wireless interface 116. Upon receiving the second connection information, the controller 106 analyzes the second connection information to determine if the second connection information includes the authentication information that was included in the first connection information. If so, then the controller 106 controls the first device 102 to establish a wireless connection with the second device 104 via the wireless interfaces 116, 122.

The encoder 108 is configured to receive the first connection information from the controller 106 and provide the encoded information to the transmitter 110. For example, the encoder 108 may be configured to encode the first connection information received from the controller 106. Encoding the first connection information includes generating a signal (for example, a current signal) indicative of the first connection information to be provided to the transmitter 110. Although the encoder 108 is shown as a separate functional module, in at least one embodiment, the functions of the encoder 108 may be performed by the controller 106.

The transmitter 110 is configured to receive the encoded information from the encoder 108, generate an output signal based on the encoded information, and transmit the output signal to the receiver 118 via the first communication medium 126. For example, the transmitter 110 may include a light-emitting device, such as an LED, configured to generate an electromagnetic radiation signal based on a received encoded signal, such as a current signal. In one example, the transmitter 110 receives the encoded information from the encoder 108 as a current signal having various values, each corresponding to different states of the light-emitting device. For example, a first state may include outputting electromagnetic radiation of a first color, a second state may include outputting electromagnetic radiation of a second color, a third state may include outputting no electromagnetic radiation, and so forth.

In other examples, the transmitter 110 may include other components. For example, the transmitter 110 may include a vibrating component, such as an imbalanced motor, configured to vibrate in a series of vibration states based on a received signal to output a vibration signal. In one example, the transmitter 110 receives the encoded information as a current signal having various values, each corresponding to different vibration states of the vibrating component. For example, a first state may include vibrating at a first frequency, a second state may include vibrating at a second frequency, and so forth.

The storage module 112 includes one or more memory and/or storage elements, and is configured to store information for operation of the controller 106. In various examples, the storage module 112 is configured to store information used to generate a passkey, such as a hash table.

The operational module 114 includes one or more modules to execute operation of the first device 102. For example, where the first device 102 is an air conditioning unit, the operational module 114 may include one or more air conditioning components, such as one or more condensers. In another example, where the first device 102 is a UPS, the operational module 114 may include one or more power conditioning components, such as one or more power converters, energy storage devices, and so forth. In still other examples, the operational module 114 may include other components depending on a device type of the first device 102.

The wireless interface 116 is configured to enable the first device 102 to wirelessly interface and communicate with other devices, such as the second device 104, via a network. For example, the network may include a radio-wave-based communication network on which the devices 102, 104 communicate via the Bluetooth or Bluetooth Low-Energy technology standard. The wireless interface 116 may send and receive signals corresponding to the communication network to and from other devices. For example, the wireless interface 116 may include an antenna configured to send and receive electromagnetic waves. In examples in which the wireless interface 116 receives the second connection information from the second device 104, the wireless interface 116 generates a current signal based on a wireless signal encoding the second connection information and provides the current signal to the controller 106.

The receiver 118 is configured to receive information transmitted by the transmitter 110, generate a signal based on the transmitted signal, and provide the generated signal to the controller 120. For example, the receiver 118 may include a photosensor configured to generate a signal (for example, a current signal) based on received electromagnetic radiation. In examples in which the signal transmitted by the transmitter 110 is electromagnetic radiation encoding first connection information and the receiver 118 is a photosensor, therefore, the receiver 118 is configured to generate a signal indicative of the first connection information encoded in the received electromagnetic radiation to provide to the controller 120.

In some examples, the receiver 118 may include other components. For example, where the transmitter 110 is a vibrating component, the receiver 118 may include an accelerometer configured to generate a signal (for example, a current signal) based on sensed vibrations in a vibration signal. In examples in which the signal transmitted by the transmitter 110 includes vibrations encoding first connection information and the receiver 118 is an accelerometer, the receiver 118 is configured to generate a signal indicative of the first connection information encoded in the received vibration signal.

The controller 120 is configured to receive the generated signal from the receiver 118, analyze information in the generated signal, and send second connection information to the wireless interface 122 based on the signal received from the receiver 116. For example, where the signal received from the first device 102 includes the first connection information, the controller 120 may analyze the first connection information and generate second connection information for establishing a wireless connection with the first device 102 based on the first connection information. The controller 120 may then provide the second connection information to the wireless interface 122.

The wireless interface 122 is configured to enable the second device 104 to interface and communicate with other devices, such as the first device 102, via the network. For example, the wireless interface 122 may include an antenna configured to send and receive electromagnetic waves. In examples in which the wireless interface 122 sends the second connection information from the controller 120 to the wireless interface 116, the wireless interface 122 encodes the second connection information (for example, in a radio wave) to generate an encoded signal, and provides the encoded signal to the wireless interface 116 via the second communication medium 128.

The storage module 124 includes one or more memory and/or storage elements, and is configured to store information for operation of the controller 120. In various examples, the storage module 124 is configured to store information used to generate the second connection information, such as a hash table used to generate a passkey.

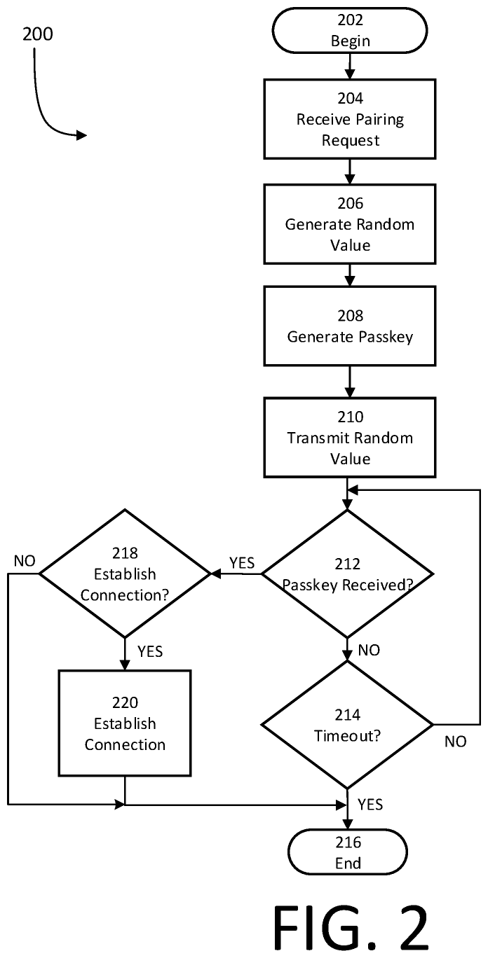

FIG. 2 illustrates a process 200 of operating the first device 102.

At act 202, the process 200 begins.

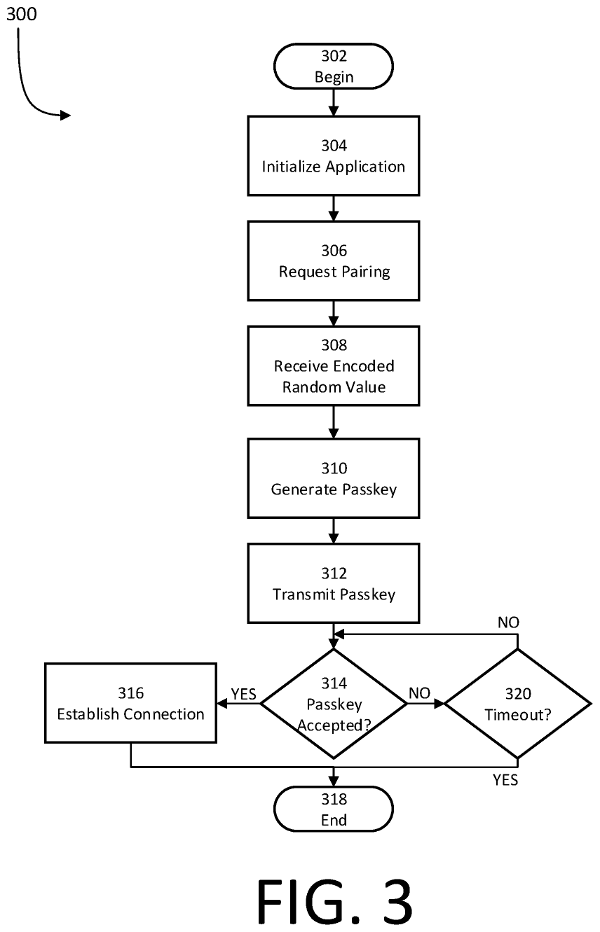

At act 204, a pairing request is received. The pairing request may be sent from the second device 104, via the wireless interface 122, to the first device 102 via the wireless interface 116. The pairing request may indicate a request for the first device 102 to form an authenticated wireless bond with the second device 104. As discussed in greater detail below with respect to FIG. 3, the pairing request may be sent by the second device 104 responsive to a user input requesting that the second device 104 send the pairing request.

At act 206, the first device 102 generates a random value. The random value may be a one-time random value generated by the controller 106 based on an implementation of the transmitter 110. For example, in one example the transmitter 110 is a light-emitting device configured to have four states, including a first state in which the light-emitting device outputs red light, a second state in which the light-emitting device outputs green light, a third state in which the light-emitting device outputs blue light, and a fourth state in which the light-emitting device is off. In this example, the random value may correspond to a series of states of the light-emitting device. For example, the random value may uniquely correspond to a specific order of light-emitting device states, such as the second state, followed by the fourth state, followed by the first state, followed by the third state. Each state may correspond to a respective two-bit value. For example, outputting electromagnetic radiation having a frequency of green light may correspond to a two-bit value of “00,” outputting electromagnetic radiation having a frequency of blue light may correspond to a two-bit value of “01,” outputting electromagnetic radiation having a frequency of red light may correspond to a two-bit value of “10,” and outputting no electromagnetic radiation may correspond to a two-bit value of “11.” In examples in which the transmitter 110 does not include a light-emitting device (for example, where the transmitter 110 includes a vibrating component), or includes a light-emitting device having a different number or types of states, the random value may correspond to the particular implementation of the transmitter.

At act 208, the first device 102 generates a passkey based on the random value. As discussed above, the storage module 112 is configured to store information indicative of a hash table. The hash table may include a data structure that maps input values to output values based on a hash function. In one example, act 208 includes executing, by the controller 106, the hash function on the random value as the input value to generate the passkey as the output value. The hash function is configured such that generating the output value from the input value is computationally simple, but determining the input value from the output value is computationally burdensome. As discussed in greater detail below, the storage module 124 of the second device 104 is also configured to store information indicative of the hash table such that the controller 120 is capable of generating the passkey based on the random value.

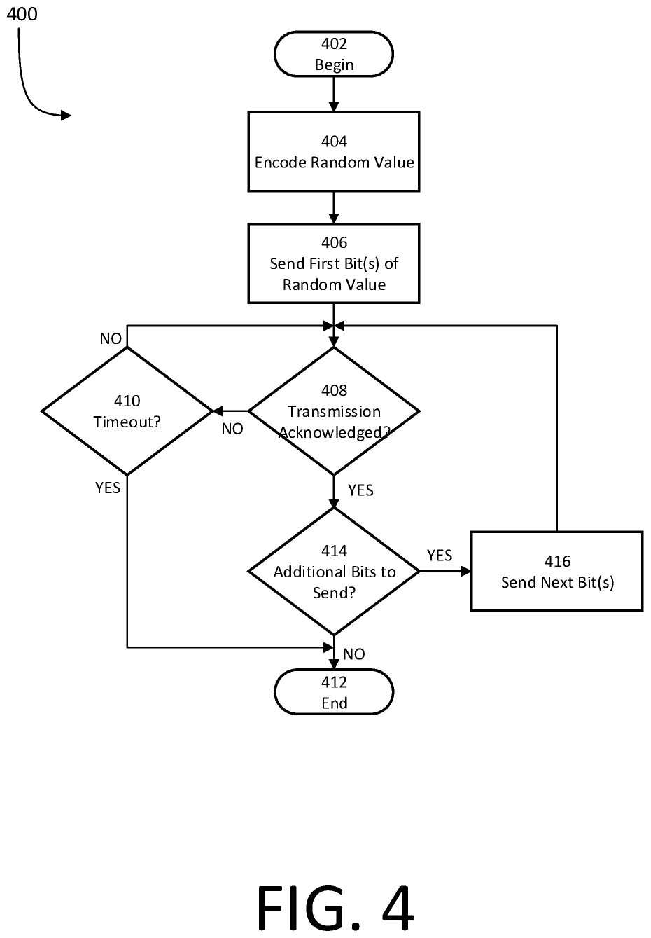

At act 210, the first device 102 transmits the random value to the second device 104. For example, the first device 102 may transmit first connection information including the random value to the second device 104 from the transmitter 110 to the receiver 118 via the communication medium 126. The encoder 108 may encode the random value in a signal configured to control operation of the transmitter 110. For example, where the transmitter 110 includes a light-emitting device, act 210 may include encoding the random value in a current signal and providing the current signal to the light-emitting device. The light-emitting device occupies a series of states, each corresponding to respective output electromagnetic radiation, based on the current signal to output an electromagnetic radiation signal to the receiver 118. An example of act 210 is discussed in greater detail below with respect to FIG. 4.

At act 212, after transmitting the random value to the second device 104, a determination is made as to whether a passkey has been received from the second device 104 based on transmitting the random value. For example, the first device 102 may receive second connection information including the passkey. If no passkey has been received from the second device 104 (212 NO), then the process 200 continues to act 214.

At act 214, a determination is made as to whether a timeout condition has been met. The timeout condition may be met where a threshold amount of time has elapsed since the random value was transmitted at act 210, which may indicate that the first device 102 is unlikely to receive a response from the second device 104. If the timeout condition has been met (214 YES), then the process 200 ends at act 216. Otherwise, if the timeout condition has not been met (214 NO), then the process 200 returns to act 212. Returning to act 212, if a determination is made that a passkey has been received from the second device 104 (212 YES), then the process 200 continues to act 218.

At act 218, a determination is made as to whether to establish a connection with the second device 104 based on the second connection information received from the second device 104. For example, the second connection information may include a passkey generated based on the random value that was transmitted to the second device 104 at act 210. Accordingly, act 218 may include determining whether the passkey received from the second device 104 at act 212 matches the passkey generated by the first device 102 at act 208. If the passkeys do not match (218 NO), then the process 200 ends at act 216. Otherwise, if the passkeys match (218 YES), then the process continues to act 220.

At act 220, a wireless connection is established between the first device 102 and the second device 104. The wireless connection may include, for example, forming a wireless connection bond pursuant to the Bluetooth or Bluetooth Low-Energy technology standard. Establishing the wireless connection bond includes providing a notification to the second device 104 that the passkey sent by the second device 104 has been accepted, and a wireless connection bond is being formed. The wireless connection enables the first device 102 and the second device 104 to freely exchange information between the wireless interfaces 116, 122 via the communication medium 128. Although certain information may be exchanged between the wireless interfaces 116, 122 prior to forming the wireless connection (for example, the pairing request received at act 204 and the passkey received at act 212), forming the wireless connection enables the second device 104 to access more sensitive information of the first device 102. For example, the second device 104 may be able to control operation of the first device 102 by sending one or more control signals to the operational module and/or the controller 106 via the wireless interfaces 116, 122, which may not be possible prior to forming the wireless connection. In addition, once the wireless connection is established, in at least one embodiment, the second device 104 may receive operational parameters of the first device 102.

At act 216, the process 200 ends.

FIG. 3 illustrates a process 300 of operating the second device 104. For example, the process 300 may include an example of operating the second device 104 where the second device 104 is a mobile user device.

At act 302, the process 300 begins.

At act 304, an application of the second device 104 is initialized. For example, the application may be a mobile device application stored in the storage module 124. The application may be initialized responsive to a user of the second device 104 providing a request to the second device 104 to initialize the application, such as by selecting the application on a user interface of the second device 104.

At act 306, a pairing request is sent from the second device 104 to the first device 102. The pairing request may be sent to the first device 102 via the wireless interfaces 116, 122. For example, the pairing request may be sent to the first device 102 responsive to a user of the second device 104 prompting the second device 104 via the application initialized at act 304 to send the pairing request.

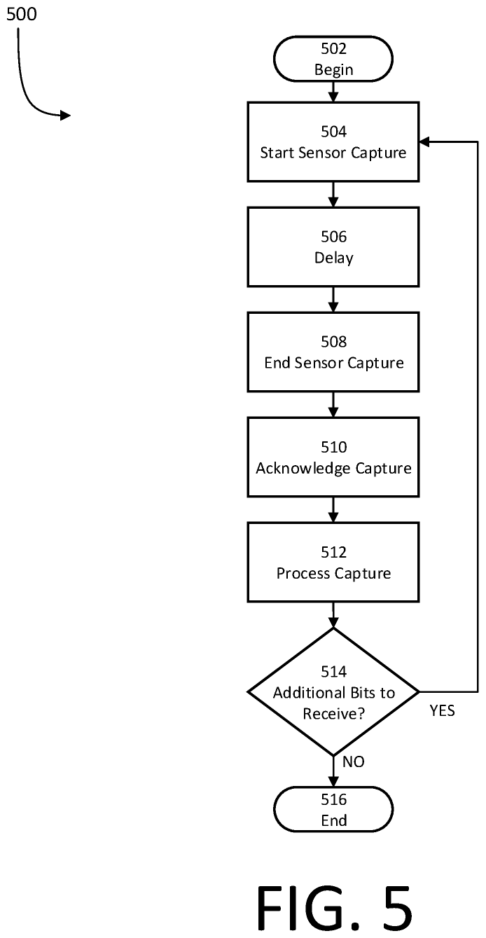

At act 308, the second device 104 receives first connection information including a random value from the first device 102 via the receiver 118. As discussed above with respect to FIG. 2, the first device 102 may transmit the encoded random value at act 210 responsive to receiving the pairing request at act 204. In examples in which the transmitter 110 is a light-emitting device transmitting the random value as an electromagnetic radiation signal including a series of light-emitting device states, the receiver 118 may include at least one photosensor configured to detect electromagnetic radiation indicative of each of the series of light-emitting device states. For example, the receiver 118 may receive an electromagnetic radiation signal indicating that the transmitter 110 is outputting green light, followed by outputting no light, followed by outputting red light, followed by outputting blue light. An example of act 308 is discussed in greater detail below with respect to FIG. 5.

At act 310, the second device 104 generates a passkey based on the random value received from the first device 102. As discussed above, the storage module 124 is configured to store information indicative of a hash table. The hash table may include a data structure that maps input values to output values based on a hash function. In one example, act 310 includes executing, by the controller 120, the hash function on the random value received from the first device 102 as the input value to generate the passkey as the output value. The hash table may be the same hash value stored by the storage module 112, such that the devices 102, 104 each generate the same passkey based on the same random value.

At act 312, the second device 104 transmits second connection information the generated passkey to the first device 102. For example, the second device 104 may transmit the second connection information to the first device 102 from the wireless interface 122 to the wireless interface 116.

At act 314, a determination is made as to whether the passkey generated by the second device 104 has been accepted by the first device 102. As discussed above, where the first device 102 establishes a wireless connection with the second device 104 at act 220, the first device 102 provides a notification to the second device 104 indicating that the passkey has been accepted. Accordingly, if the second device 104 receives a notification that the passkey has been accepted (314 YES), then the process continues to act 316.

At act 316, a wireless connection is established between the first device 102 and the second device 104. As discussed above, the wireless connection may include, for example, forming a wireless connection bond pursuant to the Bluetooth or Bluetooth Low-Energy technology standard. The wireless connection enables the first device 102 and the second device 104 to freely exchange information between the wireless interfaces 116, 122 via the communication medium 128. Although certain information may be exchanged between the wireless interfaces 116, 122 prior to forming the wireless connection (for example, the pairing request sent at act 306 and the passkey sent at act 312), forming the wireless connection enables more sensitive information to be securely exchanged.

Returning to act 314, if the passkey is not accepted (314 NO), then the process 300 continues to act 320. At act 320, a determination is made as to whether a timeout condition has been satisfied. For example, the timeout condition may be satisfied where a threshold amount of time has elapsed since the passkey was transmitted at act 312. If the timeout condition has been satisfied (320 YES), then the process 300 ends at act 318. Otherwise, if the timeout condition has not been satisfied (320 NO), then the process 300 returns to act 314.

As discussed above with respect to act 210 of the process 200, the first device 102 is configured to transmit first connection information including a random value via the transmitter 110 in some examples. FIG. 4 illustrates a process 400 of transmitting a random value according to an example.

At act 402, the process 400 begins.

At act 404, the encoder 108 encodes a random value in a signal to be provided to the transmitter 110. As discussed above, where the transmitter 110 is a light-emitting device, the random value may correspond to an electromagnetic radiation output signal including electromagnetic radiation of varying wavelengths. For example, where the random value corresponds to the transmitter 110 outputting green light, followed by being off, followed by outputting red light, followed by outputting blue light, the random value may be encoded by the encoder 108 generating a current or voltage signal that, when provided to the transmitter 110, causes the transmitter 110 to output a desired electromagnetic radiation signal. As appreciated by one of ordinary skill in the art, the light-emitting device may include one or more devices, such as LEDs, that output an electromagnetic radiation signal at a frequency corresponding to a current or voltage signal provided to the light-emitting device.

At act 406, the transmitter 110 outputs a first bit or bits of the random value to the second device 104. For example, outputting the first bit or bits may include outputting an electromagnetic radiation signal having a frequency of green light. In an example in which the transmitter 110 outputs a signal having four states (for example, emitting red light, green light, blue light, or no light), each state may correspond to a respective two-bit value. For example, and as discussed above, outputting electromagnetic radiation having a frequency of green light may correspond to a two-bit value of “00,” outputting electromagnetic radiation having a frequency of blue light may correspond to a two-bit value of “01,” outputting electromagnetic radiation having a frequency of red light may correspond to a two-bit value of “10,” and outputting no electromagnetic radiation may correspond to a two-bit value of “11.”

At act 408, a determination is made by the controller 106 as to whether the transmission of the first bit or bits of the random value has been acknowledged. As discussed below, the second device 104 may send an acknowledgement receipt in response to each received bit or bits. The acknowledgement may be received by the wireless interface 116 from the wireless interface 116. If an acknowledgement has not been received (408 NO), then the process 400 proceeds to act 410.

At act 410, a determination is made by the controller 106 as to whether a timeout condition has been met. The timeout condition may be met where a certain threshold amount of time has elapsed since the most-recently-transmitted bit or bits were output by the transmitter 110. If the timeout condition has been met (410 YES), then the process 400 ends at act 412. Otherwise, if the timeout condition has not been met (410 NO), then the process 400 returns to act 408. Returning to act 408, if a determination is made that the transmission has been acknowledged (408 YES), then the process 400 continues to act 414.

At act 414, a determination is made by the controller 106 as to whether there are additional bits to send to the second device 104. If there are no additional bits to send (414 NO), then the process 400 ends at act 412. Otherwise, if there are additional bits to send (414 YES), then the process 400 continues to act 416.

At act 416, the transmitter 110 sends the next bit of the random value. For example, the transmitter 110 may output electromagnetic radiation having a frequency corresponding to a next bit or bits of the random value. The process 400 then returns to act 408, and the process 400 repeats until a timeout condition is met (410 YES) or there are no additional bits to send (414 NO).

As discussed above with respect to act 308 of the process 300, the second device 104 is configured to receive first connection information including the random value output by the transmitter 110 via the receiver 118 in some examples. FIG. 5 illustrates a process 500 of receiving a random value according to an example.

At act 502, the process 500 begins.

At act 504, the receiver 118 starts a sensor capture. For example, where the transmitter 110 is a light-emitting device, act 504 may include the controller 120 controlling the receiver 118, which may include a photosensor, to begin sampling data. The receiver 118 therefore begins sampling data indicative of the bit or bits being output by the transmitter 110 until the receiver 118 stops a sensor capture. The receiver 118 may generate a signal, such as a current signal, indicative of the sampled data and send the signal to the controller 120. A sampling frequency of the receiver 118 may be configurable based on which parameter, such as electromagnetic radiation, is sensed by the receiver 118.

At act 506, a delay is introduced. The delay is introduced to allow the receiver 118 to receive the entirety of the bit or set of bits being transmitted by the transmitter 110. The delay may include a length of time that is configurable based on a duration necessary for the transmitter 110 to output the bit or bits.

At act 508, the receiver 118 ends the sensor capture. The controller 120 may control the receiver 118 to stop sampling data because the amount of time necessary for the transmitter 110 to output the bit or bits, represented by the delay at act 506, has elapsed, and the transmitter 110 has ceased transmitting the bit or bits.

At act 510, the bit or bits received by the receiver 118 are acknowledged by the second device 104. For example, the controller 120 may control the wireless interface 122 to output an acknowledgement signal to the wireless interface 116. As discussed above with respect to act 408, the first device 102 may output additional bits based on receipt of the acknowledgement signal.

At act 512, the controller 120 processes the data captured by the receiver 118. As discussed above, the receiver 118 may provide an output signal (for example, a current signal) to the controller 120 based on a captured signal (for example, an electromagnetic radiation signal output by the transmitter 110), and act 512 may include determining, based on the output signal, one or more bits encoded by the captured signal. For example, if the output signal indicates that the captured signal was transmitted as electromagnetic radiation having a frequency of green light, act 512 may include determining, based on the output signal, that the captured signal encoded a value of “00,” consistent with the example provided above.

At act 514, a determination is made by the controller 120 as to whether there are additional bits to receive. For example, where the first device 102 is configured to output an electromagnetic radiation signal having four states (including, for example, red light, blue light, green light, and no light), the controller 120 may determine if one or more bits representing all four states have been received. If not, then the controller 120 determines that there are additional bits to receive (514 YES), and the process 500 returns to act 504. Otherwise, if there are no additional bits to receive (514 NO), then the process 500 ends at act 516.

Examples have been provided in which the first device 102 transmits connection information to establish a wireless connection in a wireless medium via an out-of-band medium other than the wireless medium. Examples have been provided in which the out-of-band medium includes visible electromagnetic radiation signals having various colors in various orders. In other examples, the out-of-band medium may include vibration signals. For example, the transmitter 110 may be a vibrating component configured to output a vibration signal encoding the connection information and the receiver 118 may be an accelerometer configured to sense the vibration signal. Accordingly, while certain examples provided above with respect to the processes 200-500 discuss electromagnetic radiation signals being transmitted via the connection medium 126 for purposes of explanation, it is to be appreciated that the processes 200-500 may be executed where the transmitter 110 includes a component other than a light-emitting device, and the receiver 118 includes a component other than a photosensor. Similarly, while the transmitter 110 may include a multi-color light-emitting device in some examples, it is to be appreciated that the transmitter 110 may include a monochromatic light-emitting device.

Various controllers, such as the controllers 106, 120, may execute various operations discussed above. Using data stored in associated memory, the controllers 106, 120 also execute one or more instructions stored on one or more non-transitory computer-readable media that may result in manipulated data. In some examples, the controllers 106, 120 may include one or more processors or other types of controllers. In one example, the controllers 106, 120 are or include a commercially available, general-purpose processor. In another example, the controllers 106, 120 perform at least a portion of the operations discussed above using an application-specific integrated circuit (ASIC) tailored to perform particular operations in addition to, or in lieu of, a general-purpose processor. As illustrated by these examples, examples in accordance with the present invention may perform the operations described herein using many specific combinations of hardware and software and the invention is not limited to any particular combination of hardware and software components.

Current peripheral devices, such as cooling devices and uninterruptible power supplies, may be compromised by exchanging wireless connection authentication information via certain media. Although certain existing peripheral devices include user interface displays to display authentication information, user interface displays are costly and require a human user to read and enter information displayed on the user interface display, which is time-consuming and may result in errors. This is a technical problem. An exemplary embodiment of a peripheral device may comprise one or more light-emitting devices, a wireless communication interface, and a controller configured to receive a wireless connection request at the wireless communication interface, generate a secret value responsive to receiving the wireless connection request, control the light-emitting device to output a signal encoding the secret value to an external device, receive, from the external device via the wireless communication interface, information indicative of the secret value, and establish a wireless connection with the external device via the wireless communication interface based on the receipt of the information indicative of the secret value. At least this foregoing combination of features comprises a peripheral device that serves as a technical solution to the foregoing technical problem. This technical solution is not routine and is unconventional. This technical solution is a practical application of the peripheral device design that solves the foregoing technical problem and constitutes an improvement in the technical field of peripheral device design at least by facilitating increasing security in establishing a wireless device connection while reducing costs and minimizing a burden on human operators.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A peripheral device comprising:
at least one light-emitting device;
a wireless communication interface; and
at least one controller configured to:
receive a wireless connection request at the wireless communication interface;
generate a secret value responsive to receiving the wireless connection request;
control the at least one light-emitting device to output a signal indicative of the secret value to an external device;
generate a first secret authentication passkey by hashing the secret value with a hash table;
receive, from the external device via the wireless communication interface, a second secret authentication passkey generated based on the secret value; and
establish a wireless connection with the external device via the wireless communication interface based on a comparison of the first secret authentication passkey and the second secret authentication passkey,
wherein controlling the at least one light-emitting device to output the signal indicative of the secret value includes controlling the at least one light-emitting device to output a series of different colors.

2. The peripheral device of claim 1, wherein the at least one light-emitting device is a multi-color light-emitting diode (LED).

3.-5. (canceled)

6. The peripheral device of claim 1, wherein the wireless connection is a Bluetooth Low-Energy technology standard connection.

7. A non-transitory computer-readable medium storing thereon sequences of instructions for controlling a device comprising a light-emitting device and a wireless communication interface, the sequences of computer-executable instructions including instructions that instruct at least one processor to:
receive a wireless connection request at the wireless communication interface;
generate a secret value responsive to receiving the wireless connection request;
control the light-emitting device to output a signal indicative of the secret value to an external device;
generate a first secret authentication passkey by hashing the secret value with a hash table;
receive, from the external device via the wireless communication interface, a second secret authentication passkey generated based on the secret value; and
establish a wireless connection with the external device via the wireless communication interface based on a comparison of the first secret authentication passkey and the second secret authentication passkey,
wherein controlling the light-emitting device to output the signal indicative of the secret value includes controlling the light-emitting device to output a series of different colors.

8. The non-transitory computer-readable medium of claim 7, wherein the light-emitting device is a multi-color light-emitting diode (LED).

9.-11. (canceled)

12. The non-transitory computer-readable medium of claim 7, wherein the wireless connection is a Bluetooth Low-Energy technology standard connection.

13. A non-transitory computer-readable medium storing thereon sequences of instructions for controlling a device comprising a photosensor and a wireless communication interface, the sequences of computer-executable instructions including instructions that instruct at least one processor to:
generate a wireless connection request;
send the wireless connection request to a peripheral device via the wireless communication interface;
receive, from the peripheral device, an electromagnetic radiation signal output by a light-emitting device and being indicative of a secret value;
generate, based on the secret value, a first secret authentication passkey by hashing the secret value with a hash table;
send the first secret authentication passkey to the peripheral device; and
establish a wireless connection with the peripheral device via the wireless communication interface based on sending the first secret authentication passkey to the peripheral device and the first secret authentication passkey being properly generated based on the secret value and the hash table,
wherein receiving the electromagnetic radiation signal output by the light-emitting device includes receiving an electromagnetic radiation signal having a series of different colors.

14. The non-transitory computer-readable medium of claim 13, wherein in instructing the at least one processor to receive the electromagnetic radiation signal output by the light-emitting device, the instructions are further configured to instruct the at least one processor to sense the electromagnetic radiation signal via the photosensor to acquire the secret value.

15. The non-transitory computer-readable medium of claim 14, wherein the instructions are further configured to instruct the at least one processor to derive the secret value from the electromagnetic radiation signal to obtain the secret value.

16. (canceled)

17. A method of operating a peripheral device including a light-emitting device and a wireless communication interface, the method comprising:
receiving a wireless connection request at the wireless communication interface;
generating a secret value responsive to receiving the wireless connection request;
controlling the light-emitting device to output a signal indicative of the secret value to an external device;
generating a first secret authentication passkey by hashing the secret value with a hash table;
receiving, from the external device via the wireless communication interface, a second secret authentication passkey generated based on the secret value; and
establishing a wireless connection with the external device via the wireless communication interface based on a comparison of the first secret authentication passkey and the second secret authentication passkey,
wherein controlling the light-emitting device to output the signal indicative of the secret value includes controlling the light-emitting device to output a series of different colors.

18.-20. (canceled)

21. The peripheral device of claim 1, wherein in controlling the at least one light-emitting device to output the signal indicative of the secret value to the external device, the at least one controller is configured to:
control the at least one light-emitting device to output first electromagnetic radiation; and
initiate a first timeout timer.

22. The peripheral device of claim 21, wherein the at least one controller is further configured to:
receive, from the external device, an acknowledgement of the first electromagnetic radiation;
control, responsive to determining that the first timeout timer has not expired and responsive to receiving the acknowledgment of the first electromagnetic radiation, the at least one light-emitting device to output second electromagnetic radiation; and
initiate a second timeout timer.

23. The peripheral device of claim 22, wherein each of the first electromagnetic radiation and the second electromagnetic radiation corresponds to a respective color of the at least one light-emitting device.

24. The peripheral device of claim 22, wherein the first electromagnetic radiation corresponds to a first portion of the secret value, and the second electromagnetic radiation corresponds to a second portion of the secret value.

25. The peripheral device of claim 21, wherein the at least one controller is further configured to control, responsive to determining that the first timeout timer has expired, the at least one light-emitting device to discontinue outputting the signal and terminating the wireless connection request.

26. The non-transitory computer-readable medium of claim 7, wherein in instructing the at least one processor to control the light-emitting device to output the signal indicative of the secret value to the external device, the instructions are further configured to instruct the at least one processor to:
control the light-emitting device to output first electromagnetic radiation;
initiate a first timeout timer;
receive, from the external device, an acknowledgement of the first electromagnetic radiation;
control, responsive to determining that the first timeout timer has not expired responsive to receiving the acknowledgment of the first electromagnetic radiation, the light-emitting device to output second electromagnetic radiation; and
initiate a second timeout timer.

27. The non-transitory computer-readable medium of claim 13, wherein the instructions further instruct the at least one processor to:
receive, from the peripheral device, a first portion of the electromagnetic radiation signal output by the light-emitting device; and
send a first acknowledgment of the first portion of the electromagnetic radiation signal to the peripheral device.

28. The non-transitory computer-readable medium of claim 27, wherein the instructions further instruct the at least one processor to:
receive, from the peripheral device responsive to sending the first acknowledgement of the first portion of the electromagnetic radiation signal to the peripheral device, a second portion of the electromagnetic radiation signal output by the light-emitting device; and
send a second acknowledgment of the second portion of the electromagnetic radiation signal to the peripheral device.

29. The non-transitory computer-readable medium of claim 28, wherein the instructions further instruct the at least one processor to:
determine a first portion of the secret value based on the first portion of the electromagnetic radiation signal; and
determine a second portion of the secret value based on the second portion of the electromagnetic radiation signal.

30. The method of claim 17, wherein controlling the light-emitting device to output the signal indicative of the secret value to the external device includes:
controlling the light-emitting device to output first electromagnetic radiation;
initiating a first timeout timer;
receiving, from the external device, an acknowledgement of the first electromagnetic radiation;
controlling, responsive to determining that the first timeout timer has not expired responsive to receiving the acknowledgement of the first electromagnetic radiation, the light-emitting device to output second electromagnetic radiation; and
initiating a second timeout timer.
